(19) United States
(12) Patent Application Publication
(10) Pub. No.: US 2025/0030098 A1
(43) Pub. Date: Jan. 23, 2025

(54) BATTERY CELL ASSEMBLY AND BATTERY PACK INCLUDING THE SAME

(71) Applicant: LG ENERGY SOLUTION, LTD., Seoul (KR)

(72) Inventors: Sung Hwan JANG, Daejeon (KR); Gwan Woo KIM, Daejeon (KR); Da Young KIM, Daejeon (KR); Jae Wook KIM, Daejeon (KR)

(21) Appl. No.: 18/618,808

(22) Filed: Mar. 27, 2024

(30) Foreign Application Priority Data
Jul. 21, 2023 (KR) 10-2023-0095468

(51) Int. Cl. H01M 50/242; H01M 10/613; H01M 10/658; H01M 50/211; H01M 50/262

(52) U.S. Cl. CPC H01M 50/242; H01M 10/613; H01M 10/658; H01M 50/211; H01M 50/262; H01M 2220/20

(57) ABSTRACT

A battery assembly includes a first cell block; a first cover coupled to a first side of the first cell block; and a second cover coupled to a second side of the first cell block opposite the first side. The first cover includes a first extending portion extending from the first cover. The first extending portion includes a first plate spaced apart from a surface of the first cover in a first direction. The first extending portion further includes a second plate between the first plate and the first surface of the first cover.

The present application claims priority to Korean Patent Application No. 10-2023-0095468 filed on Jul. 21, 2023 in the Republic of Korea, the disclosures of which are incorporated herein by reference.

### TECHNICAL FIELD

The present disclosure relates to a battery cell assembly and a battery pack including the battery cell assembly.

### BACKGROUND

Unlike primary batteries, secondary batteries are chargeable and dischargeable multiple times. The secondary batteries are widely used as an energy source for various wireless devices such as handsets, laptop computers, and cordless vacuum cleaners. In recent years, as manufacturing costs per unit capacity of secondary batteries dramatically decrease due to energy density improvement and economies of scale, and a cruising distance of battery electric vehicles (BEV) increases to a level equivalent to that of fuel vehicles, the primary use of secondary batteries shifts from mobile devices to mobilities.

As secondary batteries are used for mobility, there is a growing need for the safety of secondary batteries. When an accident such as a fire occurs in the secondary batteries used for mobility, the life of a driver can be endangered, and thus research on technology for improving the safety of secondary batteries is essential.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure is directed to providing a battery cell assembly and a battery pack with improved safety.

This and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

In one example, a battery assembly may include: a first cell block; a first cover coupled to a first side of the first cell block; and a second cover coupled to a second side of the first cell block opposite the first side. The first cover may include a first extending portion extending from a surface of the first cover. The first extending portion may include a first plate spaced apart from the surface of the first cover in a first direction. The first extending portion may further include a second plate between the first plate and the surface of the first cover.

In other aspects, the battery assembly described herein may include one or more of the following features. The first plate may include a rectangular shape. The first plate and the second plate may extend in a second direction crossing the first direction. The battery assembly may further include a third plate between the first plate and the surface of the first cover. A first edge of the second plate may extend in the first direction between the first plate and the first cover. The second plate and the third plate may be spaced apart from each other. The first cover, the first plate, the second plate, and the third plate may form a single integrated structure. The first plate, the second plate, and the third plate may be arranged to form an insulating space between the first plate and the surface of the first cover and between the second plate and the third plate. The insulating space may extend in a second direction from the first edge of the second plate to a second edge of the second plate. The second cover may include a second extending portion extending in a third direction from the second side of the cell block. The battery cell assembly may further include a third cover coupled to a third side of the first cell block. The third cover may include a cooling channel. The battery assembly may further include: a second cell block; a third cover coupled to a first side of the second cell block, the first side of the second cell block facing the first cell block; and a fourth cover coupled to a second side of the second cell block opposite the first side of the second cell block. The third cover may include a second extending portion extending from a surface of the third cover. The second extending portion of the third cover may include a plurality of connection flanges spaced apart from each other and connected to the first extending portion of the first cover. The third cover and the plurality of connection flanges may form a single integrated structure. The battery assembly may further include: a third cell block; a fifth cover coupled to a first side of the third cell block; and a third extending portion extending from a surface of the fifth cover. The third extending portion may be configured to be fastened to a housing. The fourth cover may include a fourth extending portion, the fourth extending portion being configured to be coupled to the housing. The battery pack may further include: a third cell block; a fifth cover coupled to a first side of the third cell block; and a third extending portion extending from a surface of the fifth cover. The third extending portion may be coupled to the second cover and a housing.

In another example, a battery pack may include: a housing accommodating a battery assembly. The battery assembly may include: a first cell block; a first cover coupled to a first side of the first cell block; and a second cover coupled to a second side of the first cell block opposite the first side. The first cover may include a first extending portion extending from a surface of the first cover. The battery assembly may also include a third cover coupled to the housing covering the battery assembly. A first side of the battery assembly may be coupled to the third cover and a second side of the battery assembly may be spaced apart from a surface of the housing.

In other aspects, the battery pack described herein may include one or more of the following features. The battery assembly may include a cell block comprising a pouch-type battery cell. The housing may include a supporting structure on the surface of the housing. The first extending portion may be fastened to the supporting structure by fastening member. The battery assembly may further include: a second cell block; a fourth cover coupled to a first side of the second cell block, the first side of the second cell block facing the first cell block; and a fifth cover coupled to a second side of the second cell block opposite the first side of the second cell block. The fourth cover may include a second extending portion extending from a surface of the fourth cover. The battery assembly may further include a fourth cover coupled to a third side of the first cell block. The third cover may include a cooling channel. The third cover may be between the fourth cover and the third side of the first cell block.

In yet another example, the present disclosure may be directed to providing a battery cell assembly including a cell block including a plurality of battery cells, a first side frame provided on a first side surface of the cell block, and a second side frame provided on a second side surface of the cell block, which is opposite to the first side surface of the cell block, wherein the first side frame includes a fixed frame coupled to the first side surface of the cell block, a barrier plate connected to the fixed frame and spaced apart from the first side surface of the cell block in a first direction to form an insulating space, and a connection plate extending between the barrier plate and the fixed frame.

In exemplary embodiments, the barrier plate has a flat plate shape.

In exemplary embodiments, each of the barrier plate and the connection plate may extend in a second direction crossing the first direction.

In exemplary embodiments, the connection plate may include a lower connection plate extending in the first direction from a lower end portion of the barrier plate to the fixed frame, and an upper connection plate extending in the first direction from an upper end portion of the barrier plate to the fixed frame, wherein, the lower connection plate and the upper connection plate may be spaced apart from each other with the insulating space therebetween.

In exemplary embodiments, the fixed frame, the barrier plate, the lower connection plate, and the upper connection plate may form one body.

In exemplary embodiments, when viewed from a cross section, the insulating space may be defined by being surrounded by the barrier plate, the lower connection plate, and the upper connection plate, and the insulating space may extend continuously from one end to the other end of the barrier plate in a second direction crossing the first direction.

In exemplary embodiments, the second side frame may include a plurality of connection flanges protruding in the first direction from the second side surface of the cell block and spaced apart from each other in a second direction crossing the first direction.

In exemplary embodiments, the battery cell assembly may further include a cooling plate attached to an upper surface of the cell block so as to cover the upper surface of the cell block, and including a cooling channel.

The present disclosure is also directed to providing a battery pack including a pack housing, and a plurality of battery cell assemblies mounted in the pack housing and arranged in a first direction, wherein the plurality of battery cell assemblies include a first battery cell assembly and a second battery cell assembly that are adjacent in the first direction, wherein the first battery cell assembly includes a first cell block including a plurality of first battery cells, a first side frame coupled to one side surface of the first cell block, and a second side frame coupled to the other side surface of the first cell block opposite to the one side surface of the first cell block and including a plurality of first connection flanges spaced apart from each other in a second direction crossing the first direction, wherein each of the plurality of first connection flanges is fastened to the pack housing, and the second battery cell assembly includes a second cell block including a plurality of second battery cells, a third side frame coupled to one side surface of the second cell block facing the first cell block, and a fourth side frame coupled to the other side surface of the second cell block opposite to the one side surface of the second cell block, wherein the third side frame includes a fixed frame coupled to the one side surface of the second cell block, a barrier plate connected to the fixed frame and spaced apart from the one side surface of the second cell block in the first direction to form an insulating space, and a connection plate extending between the barrier plate and the fixed frame and fastened to the plurality of first connection flanges and the pack housing.

In exemplary embodiments, the connection plate may include a lower connection plate extending in the first direction from a lower end portion of the barrier plate to the fixed frame, and an upper connection plate extending in the first direction from an upper end portion of the barrier plate to the fixed frame, and the insulating space may be defined by being surrounded by the barrier plate, the lower connection plate, and the upper connection plate.

In exemplary embodiments, the fixed frame, the barrier plate, the lower connection plate, and the upper connection plate may form one body.

In exemplary embodiments, the plurality of battery cell assemblies may further include a third battery cell assembly located on one side of the second battery cell assembly, the fourth side frame may include a plurality of second connection flanges spaced apart from each other in the second direction, and each fastened to the pack housing, and the third battery cell assembly may include a third cell block including a plurality of third battery cells, and a fifth side frame coupled to one side surface of the third cell block facing the second cell block and including a plurality of third connection flanges spaced apart from each other in the second direction, wherein each of the plurality of third connection flanges is fastened to the pack housing.

In exemplary embodiments, the plurality of battery cell assemblies may further include a third battery cell assembly located on one side of the second battery cell assembly, and the fourth side frame may include a plurality of second connection flanges spaced apart from each other in the second direction, wherein each of the plurality of second connection flanges is fastened to the pack housing, wherein the third battery cell assembly may include a third cell block including a plurality of third battery cells, and a fifth side frame coupled to one side surface of the third cell block facing the second cell block, an insulating space defined by being surrounded by the fifth side frame may be provided at one side of the third cell block, and the fifth side frame may be coupled to the plurality of second connection flanges and the pack housing.

In exemplary embodiments, the pack housing may include a lower housing accommodating the plurality of battery cell assemblies, and a top plate coupled to the lower housing so as to cover the plurality of battery cell assemblies, and the plurality of battery cell assemblies may be suspended and supported by the top plate.

In exemplary embodiments, each of the plurality of battery cell assemblies may include a cell block in which pouch-type battery cells are stacked.

According to exemplary embodiments of the present disclosure, the plurality of battery cell assemblies are coupled to a pack housing by a side mounting method in a battery pack, so that damage due to swelling of a battery cell can be reduced, and the structural safety of the plurality of battery cell assemblies can be improved.

Furthermore, according to exemplary embodiments of the present disclosure, an insulating space formed by a side frame is provided between a plurality of battery cell assemblies adjacent to each other, so that, between the adjacent battery cell assemblies, heat transfer can be suppressed and chain ignition can be prevented. Accordingly, safety of the battery pack can be improved.

The effects obtained in exemplary embodiments of the present disclosure are not limited to the above-mentioned effects, and other effects not mentioned above may be clearly derived and understood by a person skilled in the art to which the exemplary embodiments of the present disclosure belong from the following description. That is, unintended effects in implementing exemplary embodiments of the present disclosure may also be derived by a person skilled in the art from the exemplary embodiments of the present disclosure.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawings.

FIG. 1 is a cross-sectional view illustrating a battery pack according to exemplary embodiments of the present disclosure.

FIG. 2 is a plan view illustrating the battery pack according to exemplary embodiments of the present disclosure.

FIG. 3 is a perspective view illustrating side frames provided in the battery pack according to exemplary embodiments of the present disclosure.

FIG. 4 is a plan view illustrating a battery pack according to exemplary embodiments of the present disclosure.

FIG. 5 is a plan view illustrating a battery pack according to exemplary embodiments of the present disclosure.

FIG. 6 is a cross-sectional view illustrating a battery pack according to exemplary embodiments of the present disclosure.

FIG. 7 is a schematic view illustrating an electric vehicle equipped with the battery pack of the present disclosure.

### DETAILED DESCRIPTION

Hereinafter, exemplary embodiments of the present disclosure will be described in detail with reference to the accompanying drawings. Prior to this, the terms and words used in the present specification and claims should not be construed as being limited to general or dictionary terms and should be interpreted with the meaning and concept in accordance with the technical idea of the present disclosure based on the principle that the inventors have appropriately defined the concepts of terms in order to explain the disclosure in the best way.

Therefore, since the embodiments described herein and the configurations illustrated in the drawings are merely one of the most preferred embodiments of the present disclosure and do not represent the overall technical idea of the present disclosure, it should be understood that the present disclosure covers various equivalents, modifications, and substitutions at the time of filing of this application.

Further, in the following description of the present disclosure, a detailed description of known configurations or functions incorporated herein will be omitted when it is determined that the description may make the gist of the present disclosure rather unclear.

Since the embodiments of the present disclosure are provided to more fully illustrate the present disclosure to those of ordinary skill in the art, the shapes and sizes of components in the drawings may be exaggerated, omitted, or schematically illustrated for clarity. Thus, the size or ratio of each component is not entirely reflecting the actual size or ratio.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The terms including the ordinal number such as “first”, “second” and the like, may be used to distinguish one element from another among various elements, but not intended to limit the elements by the terms. The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a nonexclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±5% of a stated or understood value.

In addition, throughout the specification, when a portion is referred to as being “connected” or “coupled” to another portion, it is not limited to the case that they are “directly connected” or “directly coupled”, but it also includes the case where they are “indirectly connected” or “indirectly coupled” with one or more elements being arranged between them.

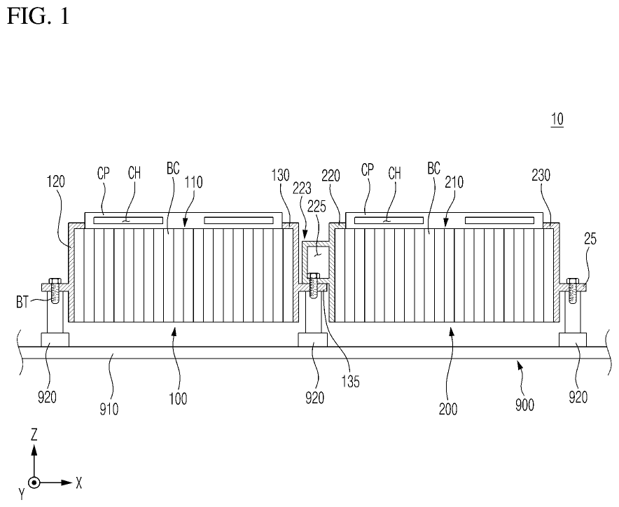

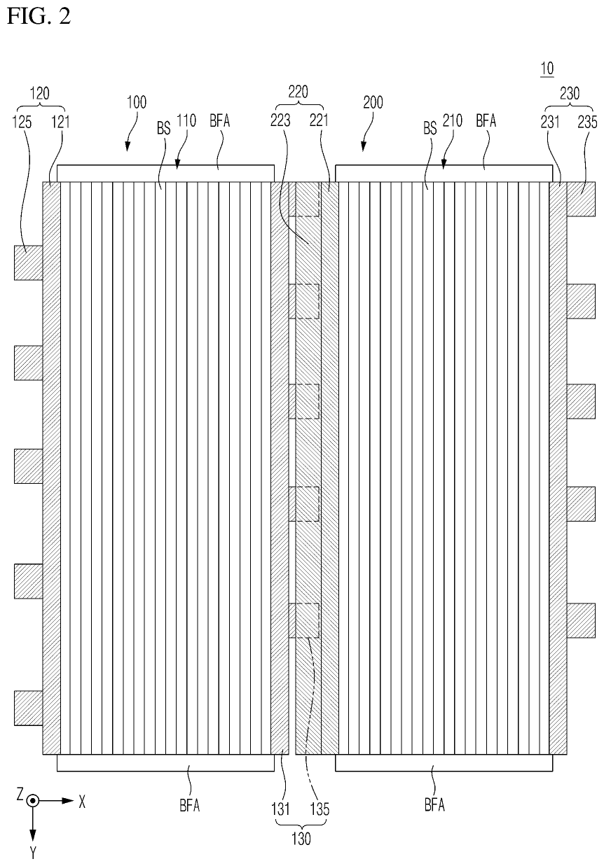

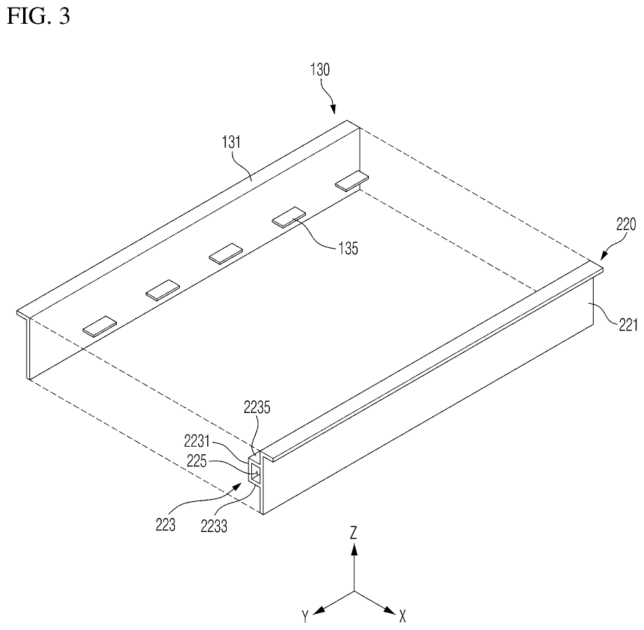

FIGS. 1 to 3 are views illustrating a battery pack 10 according to exemplary embodiments of the present disclosure, wherein FIG. 1 is a cross-sectional view illustrating the battery pack 10, FIG. 2 is a plan view illustrating the battery pack 10, and FIG. 3 is a perspective view illustrating side frames provided to the battery pack 10.

Referring to FIGS. 1 to 3, the battery pack 10 may include a pack housing 900 and a plurality of battery cell assemblies (e.g., a first battery cell assembly 100 and a second battery cell assembly 200) mounted in the pack housing 900.

The plurality of battery cell assemblies may be arranged in a first direction (X direction) in the pack housing 900. In FIG. 1, in an example, the plurality of battery cell assemblies include two battery cell assemblies (i.e., the first battery cell assembly 100 and the second battery cell assembly 200). However, the present disclosure is not limited thereto, and the battery pack 10 may include one battery cell assembly or three or more battery cell assemblies arranged in the first direction (X direction).

Each battery cell assembly may include a cell block (e.g., a first cell block 110 of the first battery cell assembly 100 or a second cell block 210 of the second battery cell assembly 200), and the cell block may include a plurality of battery cells BC. In exemplary embodiments, the battery cell assembly may be a battery module including a module case surrounding upper, lower, left, and right surfaces of the cell block, or may be a device having a shape in which some or all of the module case is removed.

Each of the battery cells BC may be a basic unit of a lithium-ion battery, for example, a secondary battery. Each battery cell BC may include an electrode assembly, an electrolyte, and a case or housing. The electrode assembly embedded in the case may include a positive electrode, a negative electrode, and a separator interposed between the positive electrode and the negative electrode. The electrode assembly may be any one of a jelly-roll type electrode assembly and a stack type electrode assembly according to an assembly type. The jelly-roll type electrode assembly may include a wound structure of a positive electrode, a negative electrode, and a separator interposed between the positive electrode and the negative electrode. The stack-type electrode assembly may include a plurality of positive electrodes, a plurality of negative electrodes, and a plurality of separators respectively interposed therebetween, all of which are sequentially stacked on one another.

The plurality of battery cells BC may be connected in series and/or in parallel. As an example, the plurality of battery cells BC may be connected in series to each other. As an example, the plurality of battery cells BC may be connected in parallel to each other. As an example, the plurality of battery cells BC connected in parallel may form groups, and the groups of the plurality of battery cells BC may be connected in series. The plurality of battery cells BC may be grouped to obtain a required electrical capacity.

Each battery cell BC may correspond to a pouch-type battery cell, a cylindrical battery cell, or a prismatic battery cell, but is not limited thereto. The electrode assembly of a pouch-type battery cell may be embedded in a pouch case including an aluminum laminate sheet. The electrode assembly of a cylindrical battery cell may be embedded in a cylindrical metal can. The electrode assembly of a prismatic battery cell may be embedded in a prismatic metal can.

In exemplary embodiments, each battery cell BC may correspond to a pouch-type battery cell, and the plurality of battery cells BC may be stacked in the first direction (X direction) in one battery cell assembly. In exemplary embodiments, in each battery cell assembly, each of the plurality of battery cells BC may correspond to a pouch-type battery cell having a length in the first direction (X direction) smaller than a length in a second direction (Y direction), and the plurality of battery cells BC may be stacked in the first direction (X direction).

In exemplary embodiments, each battery cell assembly may include a single cell block. However, the present disclosure is not limited thereto, and each battery cell assembly may include a plurality of sub-cell blocks arranged in a second direction (Y direction), and each of the plurality of sub-cell blocks may include the plurality of battery cells BC stacked in the first direction (X direction). For example, each battery cell assembly may include two sub-cell blocks arranged in the second direction (Y direction).

Referring to FIG. 2, when viewed in a plan view, each cell block may have a rectangular shape (e.g., a first cell block 110 of the first battery cell assembly 100 or a second cell block 210 of the second battery cell assembly 200). In this case, each cell block 110 or 210 may have first and second side surfaces opposite to each other in the first direction (X direction), front and rear surfaces opposite to each other in the second direction (Y direction), and upper and lower surfaces opposite to each other in a third direction (Z direction). For example, in each battery cell assembly 100, 200, the first side surface of the cell block may be a left side surface, and the second side surface of the cell block may be a right side surface.

Still referring to FIG. 2, in exemplary embodiments, in each battery cell assembly, a busbar frame BFA may be coupled to each of the front and rear surfaces of the cell block (e.g., a first cell block 110 of the first battery cell assembly 100 or a second cell block 210 of the second battery cell assembly 200). Busbars may be mounted to each busbar frame BFA to electrically connect the plurality of battery cells BC to each other. The busbars may be inter-busbars that may be connected to each battery cell BC and electrically connect multiple battery cells BC or may be terminal-busbars for electrically connecting the battery cell assembly 100, 200 to an external electrical device. However, the arrangement of the busbar frame BFA in each battery cell assembly 100, 200 is not limited thereto, and the arrangement of the busbar frame BFA in each battery cell assembly 100, 200 may be determined by the type of battery cell BC, the arrangement of electrode leads connected to the battery cells BC, and the like. For example, in each battery cell assembly 100, 200, the busbar frame BFA equipped with busbars may be disposed on the upper or lower surface of the cell block 110, 210. Although not shown in the drawings, each battery cell assembly 100, 200 may further include end plates for covering the busbar frames BFA coupled to the front and rear surfaces of the cell block.

Referring back to FIG. 1, in exemplary embodiments, in each battery cell assembly 100, 200, a cooling plate CP may be provided on the upper surface of the cell block. For example, the cooling plate CP may be attached to the upper surface of the cell block through a thermal interface material (TIM) layer. The cooling plate CP may be referred to as a cover. The cooling plate CP may have a cooling channel CH configured to allow a cooling fluid to flow therethrough. A cooling fluid provided from the outside of the battery cell assembly may flow into the cooling channel CH through an inlet of the cooling channel CH, flow along the cooling channel CH, and then may flow out to the outside through an outlet of the cooling channel CH. Cooling of the battery cell assembly 100, 200 may be performed while the cooling fluid flows along the cooling channel CH.

Still referring to FIG. 1, each of the plurality of battery cell assemblies 100, 200 may have a side mounting structure that is fastened to a support block 920 of the pack housing 900 through the side frame provided at each side portion thereof. The side frame may be connected or coupled to one side surface of the corresponding battery cell assembly. Hereinafter, the side mounting structures of the first battery cell assembly 100 and the second battery cell assembly 200 will be described in more detail.

In exemplary embodiments, the first battery cell assembly 100 may include the first cell block 110, a first side frame 120 coupled to the first side surface of the first cell block 110 and the pack housing 900, and a second side frame 130 coupled to the second side surface of the first cell block 110 and the pack housing 900.

Referring to FIG. 2, the first side frame 120 may include a first fixed frame 121 fixed to the first side surface of the first cell block 110, and a plurality of first connection flanges 125 connected to the first fixed frame 121. The first side frame 120 may be referred to as a cover. Each of the plurality of first connection flanges 125 may extend in a lateral direction (e.g., opposite to X direction) from the first side surface of the first cell block 110. The plurality of first connection flanges 125 may be referred to as an extending portion that extends from a surface of the first side frame 120. The plurality of first connection flanges 125 may be spaced apart from each other in the second direction (Y direction) and may be placed substantially at the same height in the third direction (Z direction). Each of the plurality of first connection flanges 125 may be fastened to the corresponding support block 920 among a plurality of support blocks 920, which are provided in the pack housing 900, through a fastening member such as a bolt BT, as shown in FIG. 1. The first side frame 120 may have a single integrated structure.

Still referring to FIG. 2, the second side frame 130 may include a second fixed frame 131 fixed to the second side surface of the first cell block 110, and a plurality of second connection flanges 135 connected to the second fixed frame 131. The second side frame 130 may be referred to as a cover. Each of the plurality of second connection flanges 135 may extend in the lateral direction (e.g., the first direction (X direction)) from the second side surface of the first cell block 110. The plurality of second connection flanges 135 may be referred to as an extending portion that extend from a surface of the second side frame 130. The plurality of second connection flanges 135 may be spaced apart from each other in the second direction (Y direction) and may be placed substantially at the same height in the third direction (Z direction). Each of the plurality of second connection flanges 135 may be fastened to the corresponding support block 920 among the plurality of support blocks 920, which are provided in the pack housing 900, through a fastening member such as the bolt BT, as shown in FIG. 1. The second side frame 130 may have a single integrated structure.

In the present disclosure, a side frame having a plurality of connection flanges may be referred to as a first-type side frame, and a battery cell assembly having the first-type side frame may be referred to as a first-type battery cell assembly. In this case, the first battery cell assembly 100 may correspond to the first-type battery cell assembly, and the first side frame 120 and the second side frame 130 may each correspond to the first-type side frame.

Still referring to FIG. 2, in exemplary embodiments, the second battery cell assembly 200 may include the second cell block 210, a third side frame 220 coupled to the first side surface of the second cell block 210 and the pack housing 900, and a fourth side frame 230 coupled to the second side surface of the second cell block 210 and the pack housing 900.

The third side frame 220 may include a third frame 221 fixed to the first side surface of the second cell block 210 and an insulating partition wall 223 connected to the third fixed frame 221. The third side frame 220 may be referred to as a cover. The insulating partition wall 223 may be fastened to the pack housing 900 through a fastening member such as the bolt BT, and may form an insulating space 225 between the first cell block 110 and the second cell block 210, as shown in FIG. 1. The insulating partition wall 223 may be referred to as an extending portion that extend from a surface of the third side frame 220. The third side frame 220 may have a single integrated structure.

Referring to FIG. 3, the insulating partition wall 223 may include a barrier plate 2231 and connection plates 2233 and 2235 that extend between the barrier plate 2231 and the third fixed frame 221 and may connect the barrier plate 2231 to the third fixed frame 221. The barrier plate 2231 may have the shape of a flat plate substantially perpendicular to the first direction (X direction). The connection plates 2233 and 2235 may include a lower connection plate 2233 extending from a lower end portion (or a lower edge) of the barrier plate 2231 to the third fixed frame 221, and an upper connection plate 2235 extending from an upper end portion (or an upper edge) of the barrier plate 2231 to the third fixed frame 221. As shown in FIG. 3, the barrier plate 2231 may continuously extend in the second direction (Y direction) perpendicular to the first direction (X direction), the lower connection plate 2233 may continuously extend in the second direction (Y direction) along the lower edge of the barrier plate 2231, and the upper connection plate 2235 may continuously extend in the second direction (Y direction) along the upper edge of the barrier plate 2231. The third fixed frame 221, the barrier plate 2231, the lower connection plate 2233, and the upper connection plate 2235 may be formed as one body or a single integrated structure, and may include the same material, but are not limited thereto. The insulating space 225 may be defined by being surrounded by the third fixed frame 221, the barrier plate 2231, the lower connection plate 2233, and the upper connection plate 2235. The insulating space 225 may extend in the second direction (Y direction). For example, the insulating space 225 may continuously or discontinuously extend in the second direction (Y direction) from one end to the other end of the barrier plate 2231. As shown in FIG. 1, the third side frame 220 may be fastened to the corresponding support block 920 among the plurality of support blocks 920, which are provided in the pack housing 900, through a fastening member such as the bolt BT. In exemplary embodiments, the bolt BT configured to fasten the insulating partition wall 223 of the third side frame 220 to the support block 920 may be configured to fasten the second connection flange 135 of the second side frame 130 to the support block 920. In this example, the insulating partition wall 223 of the third side frame 220 may be fastened to the second connection flange 135 of the second side frame 130. Alternatively, in exemplary embodiments, the insulating partition wall 223 of the third side frame 220 and the second connection flange 135 of the second side frame 130 may be fastened to the support block 920 by various suitable different fastening members.

Referring to FIG. 2, the fourth side frame 230 may include a fourth fixed frame 231 fixed to the second side surface of the second cell block 210, and a plurality of fourth connection flanges 235 connected to the fourth fixed frame 231. The fourth side frame 230 may be referred to as a cover. Each of the plurality of fourth connection flanges 235 may extend in the lateral direction (e.g., the first direction (X direction)) from the second side surface of the second cell block 210. The plurality of fourth connection flanges 235 may be referred to as an extending portion that extend from a surface of the fourth side frame 230. The plurality of fourth connection flanges 235 may be spaced apart from each other in the second direction (Y direction) and may be placed substantially at the same height in the third direction (Z direction). The fourth side frame 230 may have a single integrated structure. As shown in FIG. 1, each of the plurality of fourth connection flanges 235 may be fastened to the corresponding support block 920 among the plurality of support blocks 920, which are provided in the pack housing 900, through a fastening member such as the bolt BT. The fourth side frame 230 may correspond to the first-type side frame.

In the present disclosure, a side frame having a partition wall structure including an insulating partition wall configured to form an insulating space between cell blocks of adjacent battery cell assemblies may be referred to as a second-type side frame, and a battery cell assembly including the second-type side frame may be referred to as a second-type battery cell assembly. In this case, the second battery cell assembly 200 may correspond to the second-type battery cell assembly, and the third side frame 220 may correspond to the second-type side frame.

According to exemplary embodiments of the present disclosure, each battery assembly may be mounted to the pack housing 900 by a side mounting method. In the side mounting method, side frames fastened to the pack housing 900 may be provided on both sides of each battery assembly along the stacking direction of the battery cells BC. Since the plurality of battery cell assemblies are fastened to the pack housing 900 by the side mounting method in the battery pack 10, damage due to swelling of the battery cells BC may be reduced, and the structural safety of the plurality of battery cell assemblies may be improved.

Furthermore, according to exemplary embodiments of the present disclosure, since the insulating space 225 formed by the second-type side frame is provided between the plurality of battery cell assemblies adjacent to each other, between the adjacent battery cell assemblies, heat transfer may be suppressed and chain ignition may be prevented. Accordingly, the safety of the battery pack 10 may be improved.

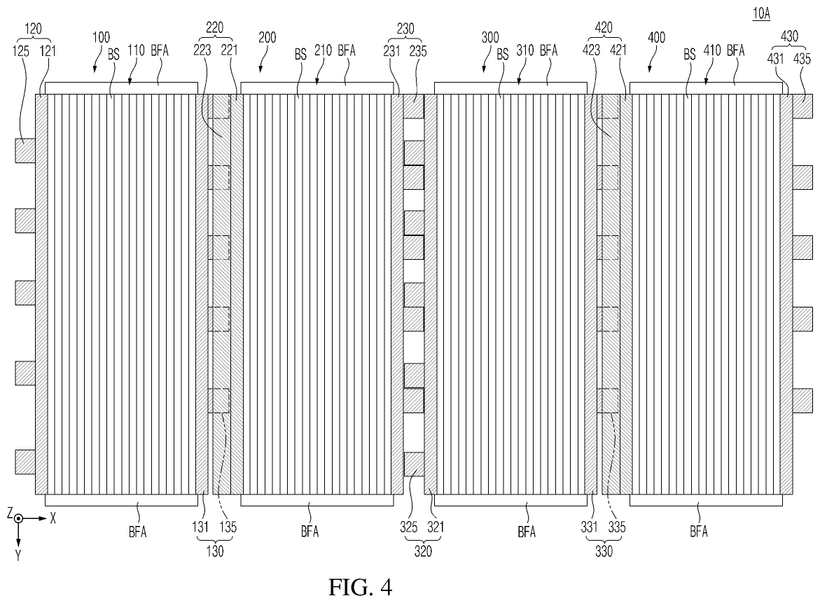

FIG. 4 is a plan view illustrating a battery pack 10A according to exemplary embodiments of the present disclosure. Hereinafter, the battery pack 10A shown in FIG. 4 will be described highlighting additional features not shown in the battery pack 10 described with reference to FIGS. 1 to 3.

Referring to FIG. 4, the battery pack 10A may include a plurality of battery cell assemblies mounted in a pack housing (see 900 of FIG. 1), and the plurality of battery cell assemblies may include the first battery cell assembly 100, the second battery cell assembly 200, a third battery cell assembly 300, and a fourth battery cell assembly 400 sequentially arranged in the first direction (X direction).

In the battery pack 10A, the first and third battery cell assemblies 100 and 300 may correspond to the first-type battery cell assembly, and the second and fourth battery cell assemblies 200 and 400 may correspond to the second-type battery cell assembly.

The third battery cell assembly 300 may include a third cell block 310, a fifth side frame 320 coupled to a first side surface of the third cell block 310 and the pack housing 900, and a sixth side frame 330 coupled to a second side surface of the third cell block 310 and the pack housing 900.

The fifth side frame 320 and the sixth side frame 330 may be the first-type side frames. More specifically, the fifth side frame 320 may include a fifth fixed frame 321 fixed to the first side surface of the third cell block 310, and a plurality of fifth connection flanges 325 connected to the fifth fixed frame 321. Each of the plurality of fifth connection flanges 325 may be fastened to the corresponding support block 920 among a plurality of support blocks (see 920 of FIG. 1), which may be provided in the pack housing 900, through a fastening member such as a bolt (see BT of FIG. 1). The plurality of fifth connection flanges 325 may be located at substantially the same level in the third direction (Z direction) and the plurality of sixth connection flanges 335 may be located at substantially the same level in the third direction (Z direction). The fifth connection flanges 325 and the sixth connection flanges 335 may be alternately arranged between the second cell block 210 and the third cell block 310. The sixth side frame 330 may include a sixth fixed frame 331 fixed to the second side surface of the third cell block 310, and a plurality of sixth connection flanges 335 connected to the sixth fixed frame 331. Each of the plurality of sixth connection flanges 335 may be fastened to the corresponding support block 920 among the plurality of support blocks 920 (see 920 of FIG. 1), which are provided in the pack housing 900, through a fastening member such as the bolt BT (see BT of FIG. 1).

The fourth battery cell assembly 400 may include a fourth cell block 410, a seventh side frame 420 coupled to a first side surface of the fourth cell block 410 and the pack housing 900, and an eighth side frame 430 coupled to a second side surface of the fourth cell block 410 and the pack housing 900.

The seventh side frame 420 corresponds to the second-type side frame, and the eighth side frame 430 may correspond to the first-type side frame. For example, the seventh side frame 420 may include a seventh fixed frame 421 fixed to the first side surface of the fourth cell block 410, and an insulating partition wall 423 defining an insulating space between the third cell block 310 and the fourth cell block 410. In exemplary embodiments, the bolt BT configured to fasten the seventh side frame 420 to the support block 920 may be configured to fasten the sixth connection flange 335 of the sixth side frame 330 to the support block 920. In this case, the insulating partition wall 423 of the seventh side frame 420 may be fastened to the sixth connection flange 335 of the sixth side frame 330. The eighth side frame 430 may include an eighth fixed frame 431 fixed to the second side surface of the fourth cell block 410, and a plurality of eighth connection flanges 435 connected to the eighth fixed frame 431. Each of the plurality of eighth connection flanges 435 may be fastened to the corresponding support block 920 among the plurality of support blocks 920 (see 920 of FIG. 1), which are provided in the pack housing 900, through a fastening member such as the bolt BT (see BT of FIG. 1).

According to exemplary embodiments of the present disclosure, since the insulating space is provided between the third cell block 310 and the fourth cell block 410 by the seventh side frame 420, between adjacent battery cell assemblies, heat transfer may be suppressed and chain ignition may be prevented. Accordingly, the safety of the battery pack 10A may be improved.

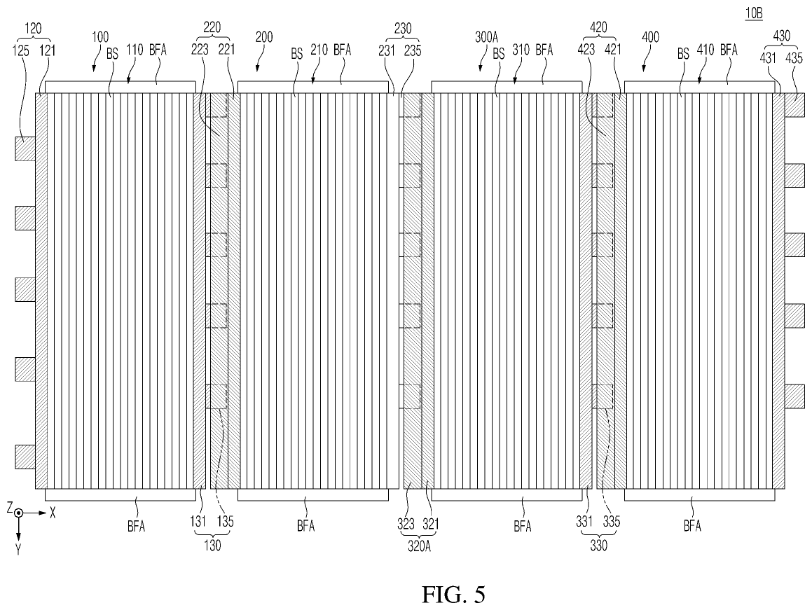

FIG. 5 is a plan view illustrating a battery pack 10B according to exemplary embodiments of the present disclosure. Hereinafter, the battery pack 10B shown in FIG. 5 will be described additional features not shown in the battery pack 10A described with reference to FIG. 4.

Referring to FIG. 5, in the battery pack 10B, a plurality of battery cell assemblies may include the first battery cell assembly 100, the second battery cell assembly 200, a third-A battery cell assembly 300A, and the fourth battery cell assembly 400 sequentially arranged in the first direction (X direction). In this case, the first battery cell assembly 100 may correspond to the first-type battery cell assembly, and the second to fourth battery cell assemblies 200, 300A, and 400 may correspond to the second-type battery cell assembly.

Specifically, in the third-A battery cell assembly 300A, a fifth-A side frame 320A corresponds to the second-type side frame, and a sixth side frame 330 may correspond to the first-type side frame. The fifth-A side frame 320A may include a sixth fixed frame 321 fixed to the first side surface of the third cell block 310, and an insulating partition wall 323 defining an insulating space between the second cell block 210 and the third cell block 310. In exemplary embodiments, a bolt BT configured to fasten the third-A side frame 320A to the support block 920 may be configured to fasten the fourth connection flange 235 of the fourth side frame 230 to the support block 920. (see 920 and BT of FIG. 1) In this case, the insulating partition wall 323 of the fifth-A side frame 320A may be fastened to the fourth connection flange 235 of the fourth side frame 230.

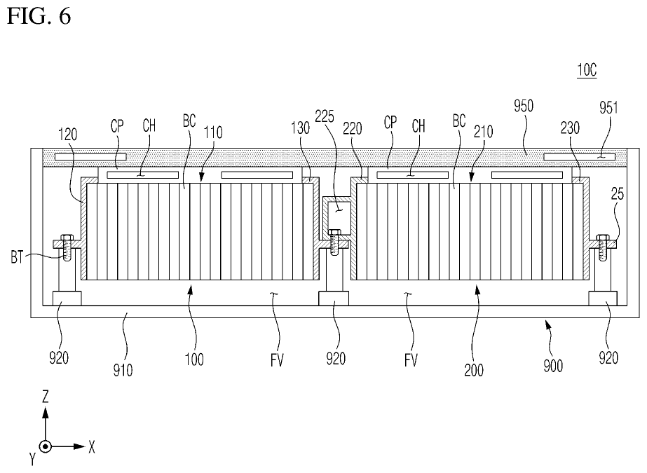

FIG. 6 is a cross-sectional view illustrating a battery pack 10C according to exemplary embodiments of the present disclosure. Hereinafter, the battery pack 10C shown in FIG. 6 will be described highlighting addition features not shown in the battery pack 10 described with reference to FIGS. 1 to 3.

Referring to FIG. 6, in the battery pack 10C, a pack housing 900 may include a lower housing 910 having an accommodation space in which a plurality of battery cell assemblies (e.g., the first battery cell assembly 100 and the second battery cell assembly 200) are accommodated, and a top plate 950 coupled to the lower housing 910 so as to cover the lower housing 910 in which the plurality of battery cell assemblies are accommodated. The accommodation space of the lower housing 910 may be defined by a bottom wall and side walls (e.g., four walls) located on the perimeter of the bottom wall. In one embodiment, the lower housing 910 may include one or more exhaust hole and/or exhaust devices on one or more of the walls of the lower housing 910. The exhaust hole and/or exhaust devices are not shown in the figure for clarity of illustration and explanation. The top plate 950 may be a pack lid covering the plurality of battery cell assemblies. The top plate 950 may be referred to as a cover. When the battery pack 10C is mounted in a vehicle, a passenger compartment in which passengers board may be located above the top plate 950, and the ground on which the vehicle travels may be located below the lower housing 910.

In exemplary embodiments, the plurality of battery cell assemblies may each be suspended and supported by the top plate 950. Each battery cell assembly may be coupled to a lower surface of the top plate 950. In addition, a free volume FV may be provided between a lower surface of the each battery cell assembly and the bottom wall of the lower housing 910. The free volume FV may be defined as a space formed by the bottom wall of the lower housing 910 and each battery cell assembly being spaced apart from each other.

The present disclosure provides an upright support structure in which each battery cell assembly may be suspended and supported by the top plate 950. In addition, the free volume FV may be provided between a bottom of the battery pack 10C (i.e., the bottom wall of the lower housing 910) and each battery cell assembly. Gas and flames generated in a thermal runaway situation may be moved through the free volume FV. That is, the free volume FV becomes a venting passage through which high-temperature gas and flames can move. Additionally, the high-temperature gas and flames moving through the free volume FV may be vented outside of the battery pack 10C via the one or more exhaust hole and/or exhaust devices described in the foregoing disclosure.

In addition, even when a strong impact is generated due to foreign material or objects that may impact a lower portion of the vehicle in a hard or rough ground driving situation such as an unpaved road, the free volume FV may absorb the impact. Thus, the plurality of battery cell assemblies (e.g., 100, 200) may be prevented from being damaged by the impact. The free volume FV may include an empty space between each of the plurality of battery cell assemblies (e.g., 100, 200) and the lower housing 910, and when the lower housing 910 is deformed toward the battery cell assembly (e.g., 100, 200) due to the impact applied to the lower portion of the vehicle, the free volume FV may be function as a space for allowing some amount of deformation of the lower housing 910. No other structures may be installed in the free volume FV. Alternatively, a structure for supporting the battery cell assembly (e.g., 100, 200) or the like may be installed in part of the free volume FV. When the structure is installed in part of the free volume FV, a space for allowing the deformation of the lower housing 910 may be provided between the battery cell assembly (e.g., 100, 200) and the lower housing 910, as shown in FIG. 6.

A height of the free volume FV, and a distance between the bottom wall of the lower housing 910 and the battery cell assembly (e.g., 100, 200) may be set to sufficiently absorb an external impact. The height of the free volume FV may be determined in consideration of the dimensions and rigidity of a vehicle frame, the dimensions and rigidity of the lower housing 910, dimensions of the battery pack 10C, the amount and discharge speed of gas generated during thermal runaway, and the like. For example, when the thickness or rigidity of the vehicle frame or the bottom wall of the lower housing 910 is relatively large, at least one of the size and height of the free volume FV may be relatively reduced. In addition, when the thickness or rigidity of the vehicle frame or the bottom wall of the lower housing 910 is relatively small, the tolerance of deformation of the bottom wall of the lower housing 910 may be large, and thus at least one of the size and the height of the free volume FV may be relatively increased in order to protect the battery cell assembly (e.g., 100, 200). In addition, when the size of the battery pack 10C is relatively large according to the specifications of the battery pack 10C, a relatively large free volume FV may be secured. When the size of the battery pack 10C is relatively small, the height of the free volume FV that may be secured may be relatively small, and it may be necessary to relatively increase the thickness and rigidity of the bottom wall of the lower housing 910. In addition, when the height of the free volume FV is too small, a gas discharge passage may be reduced so that an internal pressure of the battery pack 10C may sharply increase during thermal runaway. Accordingly, the size and height of the free volume FV may be determined in consideration of the amount and discharge speed of generated gas.

The maximum height of the free volume FV may be determined according to the degree of damage to the battery cell BC included in the battery cell assembly (e.g., 100, 200). For example, when an allowable damage limit of the battery cell BC is 1 mm, the free volume FV may be determined such that the battery cell BC is not deformed more than 1 mm when the lower housing 910 is deformed and presses or contacts a lower surface of the battery cell BC. In this case, the amount of deformation of the lower housing 910 may vary according to the thickness or rigidity of the lower housing 910. Thus, the size or height of the free volume FV may be determined in consideration of both the allowable damage limit of the battery cell BC and the thickness and rigidity of the lower housing 910.

An upper surface of each battery cell assembly (e.g., 100, 200) may be tightly coupled to the lower surface of the top plate 950. When there is a space between the battery cell assembly (e.g., 100, 200) and the top plate 950, high-temperature gas may be introduced into the space between the battery cell assembly (e.g., 100, 200) and the top plate 950 during thermal runaway, and thus heat and flames may propagate to another adjacent battery cell assembly (e.g., 100, 200). In addition, there is a concern that the heat and flames may also be transmitted to the top plate 950 to affect the passenger compartment above the top plate 950. Thus, by tightly coupling the upper surface of each battery cell assembly (e.g., 100, 200) and the lower surface of the top plate 950, gas or flames generated in the battery pack 10C may be guided to the free volume FV.

For example, each battery cell assembly (e.g., 100, 200) may be tightly coupled to the lower surface of the top plate 950 by a TIM layer interposed between each battery cell assembly (e.g., 100, 200) and the top plate 950. The TIM layer may prevent an air layer from being formed between the battery cell assembly (e.g., 100, 200) and the top plate 950. The TIM layer may be configured to transmit heat to the space between the battery cell assembly (e.g., 100, 200) and the top plate 950. Thus, heat of the battery cell assembly (e.g., 100, 200) may be discharged toward the top plate 950 through the TIM layer.

By providing an appropriate cooling device to the top plate 950, the heat of the battery cell assembly (e.g., 100, 200) may be transmitted to the cooling device through the TIM layer. The cooling device may include a cooling channel 951 which is provided, for example, to the top plate 950 and through which a cooling fluid flows. Since the TIM layer is disposed between the upper surface of each battery cell assembly (e.g., 100, 200) and the top plate 950, and the cooling channel 951 is provided in the top plate 950, the heat of the battery cell assembly (e.g., 100, 200) may be efficiently cooled.

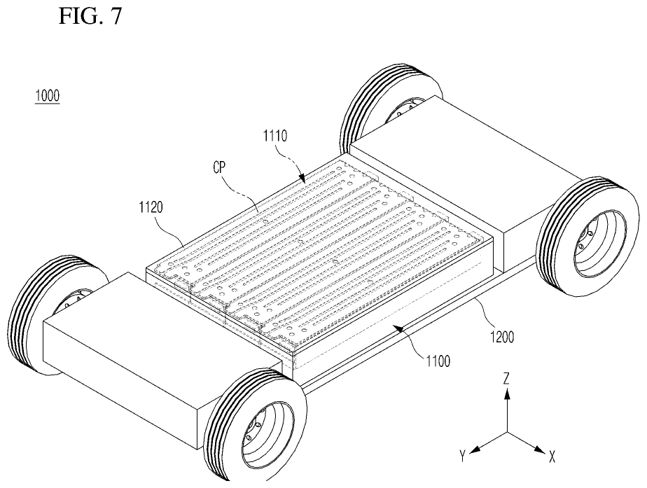

FIG. 7 is a schematic view illustrating an electric vehicle 1000 equipped with a battery pack 1100 of the present disclosure.

In FIG. 7, for clarity of illustration and explanation, only a vehicle body frame 1200 forming a lower frame of the vehicle, the battery pack 1100 coupled to the vehicle body frame 1200, and tires are shown. For example, the battery pack 1100 may correspond to any one of the battery packs 10, 10A, 10B, and 10C described with reference to FIGS. 1 to 6.

In the case of a typical battery pack, battery cell assemblies are installed on a bottom portion of a housing of the battery pack. However, in the present embodiments, each of the battery cell assemblies 1110 of the battery pack 1100 may include a structure that is suspended and supported by a top plate 1120 of the housing. That is, since there is no space between the battery cell assembly 1110 and the top plate 1120, it is possible to prevent gas generated in the battery cell assembly 1110 from being transmitted to a passenger compartment at an upper portion of the vehicle. The gas is directed to the free volume FV (see FIG. 6) provided below the battery cell assembly 1110 and in a lower portion the housing of the battery pack 1100. The gas flows through the free volume FV and is discharged to a lower side of the vehicle through a gas vent portion installed in the battery pack 1100. In addition, according to the present embodiments, since the free volume FV is provided between the battery cell assembly 1110 and the housing in the battery pack 1100, damage to the battery cell assembly 1110 may be prevented even when the housing is deformed.

According to the embodiments of the present disclosure, the battery pack 1100 and the electric vehicle 1000 having the same may enhance the safety of passengers. In addition, the battery cell assembly 1110, which is a key component, may be protected, and the durability of the battery pack 1100 and the electric vehicle 1000 may be improved.

As above, the present disclosure has been described in more detail through the drawings and embodiments. However, since the configuration described in the drawings or embodiments described herein is merely one embodiment of the present disclosure and do not represent the overall technical idea of the present disclosure, it should be understood that the present disclosure covers various equivalents, modifications, and substitutions at the time of filing of this application.

### DESCRIPTION OF REFERENCE NUMERALS

10: battery pack, 100 and 200: battery cell assemblies
110 and 210: cell blocks, 120, 130, 210, and 230: side frames
900: pack housing, 910: lower housing
920: support block. BC: battery cell
CP: cooling plate

What is claimed is:

1. A battery assembly comprising:
a first cell block;
a first cover coupled to a first side of the first cell block; and
a second cover coupled to a second side of the first cell block opposite the first side,
wherein the first cover comprises a first extending portion extending from a surface of the first cover,
wherein the first extending portion comprises a first plate spaced apart from the surface of the first cover in a first direction; and
wherein the first extending portion further comprises a second plate between the first plate and the surface of the first cover.

2. The battery assembly of claim 1, wherein the first plate has a rectangular shape.

3. The battery assembly of claim 2, wherein the first plate and the second plate extend in a second direction crossing the first direction.

4. The battery assembly of claim 1, further comprises a third plate between the first plate and the surface of the first cover,
wherein a first edge of the second plate extends in the first direction between the first plate and the first cover, and
wherein the second plate and the third plate are spaced apart from each other.

5. The battery assembly of claim 4, wherein the first cover, the first plate, the second plate, and the third plate form a single integrated structure.

6. The battery assembly of claim 5, wherein the first plate, the second plate, and the third plate are arranged to form an insulating space between the first plate and the surface of the first cover and between the second plate and the third plate, and
wherein the insulating space extends in a second direction from the first edge of the second plate to a second edge of the second plate.

7. The battery assembly of claim 1, wherein the second cover includes a second extending portion extending in a third direction from the second side of the cell block.

8. The battery cell assembly of claim 1, further comprising a third cover coupled to a third side of the first cell block, and
wherein the third cover comprises a cooling channel.

9. The battery assembly of claim 1, further comprising:
a second cell block;
a third cover coupled to a first side of the second cell block, the first side of the second cell block facing the first cell block; and
a fourth cover coupled to a second side of the second cell block opposite the first side of the second cell block,
wherein the third cover comprises a second extending portion extending from a surface of the third cover.

10. The battery assembly of claim 9, wherein the second extending portion of the third cover comprises a plurality of connection flanges spaced apart from each other and connected to the first extending portion of the first cover.

11. The battery assembly of claim 10, wherein the third cover and the plurality of connection flanges form a single integrated structure.

12. The battery assembly of claim 9, further comprising:
a third cell block;
a fifth cover coupled to a first side of the third cell block; and
a third extending portion extending from a surface of the fifth cover,
wherein the third extending portion is configured to be fastened to a housing, and
wherein the fourth cover comprises a fourth extending portion, the fourth extending portion being configured to be coupled to the housing.

13. The battery pack of claim 9, further comprising:
a third cell block;
a fifth cover coupled to a first side of the third cell block; and
a third extending portion extending from a surface of the fifth cover,
wherein the third extending portion is coupled to the second cover and a housing.

14. A battery pack comprising: a housing accommodating a battery assembly, the battery assembly comprising:
a first cell block;
a first cover coupled to a first side of the first cell block; and
a second cover coupled to a second side of the first cell block opposite the first side,
wherein the first cover comprises a first extending portion extending from a surface of the first cover; and
a third cover coupled to the housing covering the battery assembly,
wherein a first side of the battery assembly is coupled to the third cover and a second side of the battery assembly is spaced apart from a surface of the housing.

15. The battery pack of claim 14, wherein the battery assembly comprises a cell block comprising a pouch-type battery cell.

16. The battery pack of claim 14, wherein the housing comprises a supporting structure on the surface of the housing.

17. The battery pack of claim 16, wherein the first extending portion is fastened to the supporting structure by fastening member.

18. The battery pack of claim 16, wherein the battery assembly further comprises:
a second cell block;
a fourth cover coupled to a first side of the second cell block, the first side of the second cell block facing the first cell block; and
a fifth cover coupled to a second side of the second cell block opposite the first side of the second cell block,
wherein the fourth cover comprises a second extending portion extending from a surface of the fourth cover.

19. The battery pack of claim 14, wherein the battery assembly further comprises a fourth cover coupled to a third side of the first cell block, and
wherein the third cover comprises a cooling channel.

20. The battery pack of claim 19, wherein the third cover is between the fourth cover and the third side of the first cell block.
